(19) United States
(12) Patent Application Publication
(10) Pub. No.: US 2010/0229115 A1
(43) Pub. Date: Sep. 9, 2010

(54) ZOOMABLE USER INTERFACE DATA GENERATION

(75) Inventors: Matthew S. Augustine, Seattle, WA (US); Radoslav P. Nickolov, Seattle, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 12/398,196

(22) Filed: Mar. 5, 2009

(51) Int. Cl. G06F 3/048; G09G 5/00

(52) U.S. Cl. 715/800; 345/661

(57) ABSTRACT

Systems and methods for generating zoomable user interface dynamically or at scale are disclosed. In at least some implementations, at least portions of zoomable user interface information returned to a client may be generated in response to a request. In the same or other implementations, one or more of a variety of optimizations may be used to more efficiently generate zoomable user interface information.

### BACKGROUND

A variety of scenarios lend themselves to the use of “zoomable user interfaces.” Generally, a zoomable user interface is a computer-implemented user interface that uses the actions of zooming and/or panning to display or express information. As just one example, a map may be displayed initially in a “zoomed out” manner, so that more of a particular geographic area is visible. A user might then choose a particular area of interest and “zoom in” on that area to view additional information. The same or another user might pan left, right, or in any arbitrary direction, to view geographic information about an adjacent area.

Such zoomable user interfaces may be implemented in a variety of ways. For example, a naïve implementation might require a device to obtain a version of the information to be displayed that includes all of the information that can be displayed, but then only to display particular parts of this information when the display is “zoomed out.” A concrete example of such an implementation might require a user interface client to download a single and possibly relatively large image file. The client would then locally “down sample” or make the image smaller when the view is zoomed out. To display more information, the originally downloaded full size image would be displayed at its native resolution (or at least at a resolution closer to its native resolution). Unfortunately, this method often also means that a large amount of information that is never viewed must still be downloaded—a user that immediately zooms and only views a particular part of an image has no need for the detail in the rest of the image. As another example, another way to create such an interface may be to simply scale up a relatively low resolution image during a zoom operation. While this technique reduces the amount of information that must be communicated—because a low resolution image is made up of less data than a high resolution image—it also typically produces blurry and unsatisfactory images.

To resolve at least some of the previously introduced problems, some zoomable user interface systems use a variety of techniques to enable a client to display information at a variety of resolutions and at the same time not require the client to obtain a large amount of data that is never displayed or used. As just one example, generally, a system might down sample a particular image to multiple different resolutions and might also split or divide these down sampled images (and the original image) to produce “tiles” of one or more particular and sometimes relatively constant sizes. With such a system a client might be able to obtain or download smaller size versions of data associated with particular information for initial display, and then download only particular tiles that show areas of interest at higher resolutions.

The generation of the zoomable user interface information required to enable such systems to provide zoomable user interfaces—for example, the down sampling of one or more images, the generation of tiles, and so on—may generally be computationally intensive or otherwise not easily implemented at large scales. For example, it may be difficult for a system to timely satisfy a request from a client for zoomable user interface information if at least some of the information is not already generated before the client's request is received. In some cases—such as those where the information to be displayed does not change or changes infrequently—such a limitation may not always be particularly troublesome, because it may be possible to generate some or all of the required information before the information is needed. However, there are a large number of scenarios where it may be practically impossible to pre-generate all zoomable user interface information that might someday be required by some client.

### SUMMARY

The following presents a simplified summary of the disclosure in order to provide a basic understanding to the reader. This summary is not an extensive overview of the disclosure and does not identify key or critical elements of the invention or delineate the scope of the invention. Its sole purpose is to present some concepts disclosed herein in a simplified form as a prelude to the more detailed description that is presented later.

Described herein are various techniques and technologies directed to the generation of zoomable user interface dynamically or at scale. More particularly, in at least some implementations, at least portions of zoomable user interface information returned to a client may be generated “on-the-fly” or in response to a request. In at least some implementations, one or more of a variety of optimizations may be used to more efficiently generate zoomable user interface information.

### DESCRIPTION OF THE DRAWINGS

FIG. 1 illustrates an exemplary subset of zoomable user interface information that may be used as part of displaying a zoomable user interface.

FIG. 2 illustrates an exemplary system that demonstrates one manner in which zoomable user interface information may be generated and provided to a user interface client.

FIG. 3 illustrates an exemplary system that demonstrates one manner in which zoomable user interface information may be generated on a server and provided to a user interface client.

FIG. 4 illustrates an exemplary generalized operational flow including various operations that may be performed when servicing requests for zoomable user interface information.

FIG. 5 illustrates an exemplary computing environment in which the various technologies described herein may be implemented.

### DETAILED DESCRIPTION

Described herein are various techniques and technologies directed to the generation of zoomable user interface dynamically or at scale. More particularly, in at least some implementations, at least portions of zoomable user interface information returned to a client may be generated “on-the-fly” or in response to a request. In at least some implementations, one or more of a variety of optimizations may be used to more efficiently generate zoomable user interface information.

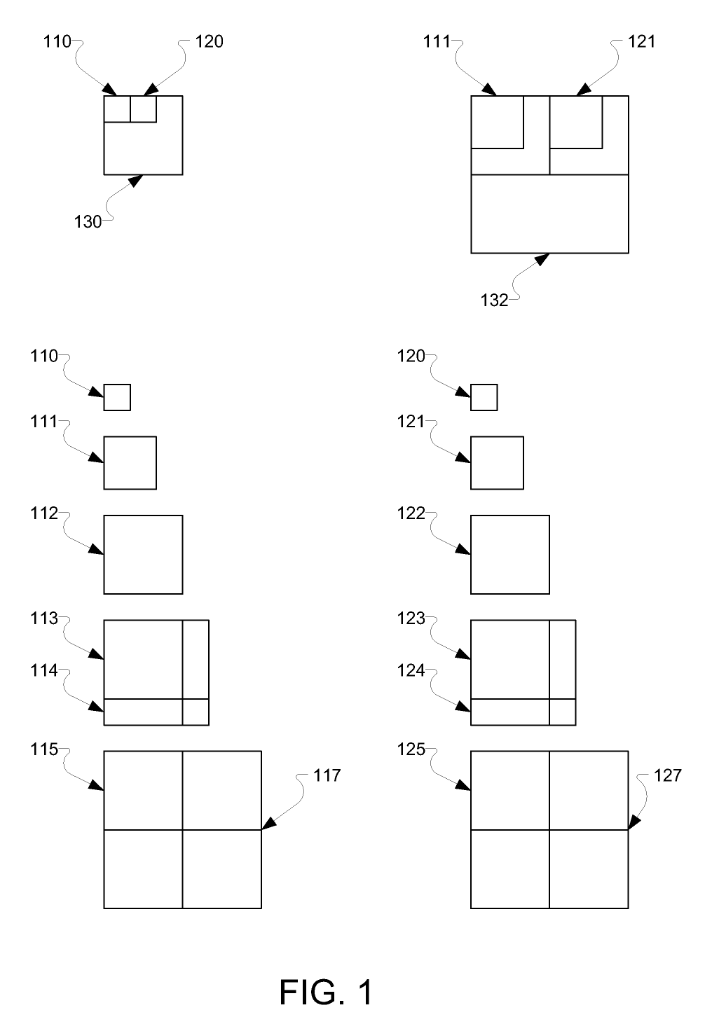

Turning now to FIG. 1, shown therein is an exemplary set of zoomable user interface information that may be used as part of displaying a zoomable user interface. The zoomable user interface information includes image pyramid tiles 110, 111, 112, 113, 114, 115, 120, 121, 122, 123, 124, 125, source information 117 and source information 127, and collection tile 130 and collection tile 132. This description of FIG. 1 may be made with reference to other figures. However, it should be understood that the elements described with reference to FIG. 1 are not intended to be limited to being used with the elements described with reference to other figures. In addition, while the exemplary diagram in FIG. 1 indicates particular elements, in some implementations not all of these elements may exist, and in some implementations additional elements may exist. Furthermore, it should be understood that the exemplary graphical representations of the elements shown in FIG. 1, and in other figures included herein, are provided only for purposes of discussion, and in no way should be construed as limiting the scope of the techniques described herein to any particular graphical or other representation.

Generally, in at least some systems for providing zoomable user interfaces, one or more pieces of source information may be processed to create zoomable user interface information. In some implementations, such zoomable user interface information includes image pyramids and collection data.

An image pyramid may, in at least some implementations and without limitation, be comprised of image pyramid tiles and image pyramid metadata. Generally, an image pyramid tile may be a representation of all or part of some source information, suitably processed so as to enable zoomable user interfaces. For example, in some implementations and without limitation, source information may comprise one or more photos. Suppose, for the sake of example, that the source information includes, say, 50 photos, each of which is of some arbitrarily size—say 3008 by 2000 pixels (source information could also be of a variety of different sizes). In this or another example, it may be desirable to display all of the photos at a single time and then enable a user to zoom in to view particular photos or a single photo more closely. So, say, a user might first view a zoomable user interface where each of the photos was of a much smaller size—say, 5 by 5 pixels—and was arranged in a grid or in some other arbitrary arrangement.

After viewing the initial set of images, the user might zoom in to a particular location in the displayed grid or arrangement, and the photos in some proximity to that location might then be made larger so additional detail can be seen. For example, a user might view photos in a particular part of the arrangement at a size of 10 by 10 pixels, then at 20 by 20 pixels, and so on, possibly all the way up to the size of the original source information (3008 by 2000 pixels in this example), or even at larger sizes through up sampling or other techniques. In some implementations, the act of zooming might be indicated using a variety of input devices, including for example and without limitation, the use of a scroll wheel on a mouse, by pressing particular keys on a keyboard, by pinching parts of a touch-sensitive display with a user's fingers, and so on. A user might also pan, or translate the current viewed location in some direction and so view different photos or different portions of a particular photo, through the use of a variety of user input actions, including moving a mouse, pressing keys on a keyboard, dragging with a finger on a touch-sensitive screen, and so on.

It should be noted that source information is not limited to photographs. Instead, in at least some implementations, source information may be any information for which a visual representation may be generated or obtained. For example, source information might include drawings, maps, or a variety of other things that may be seen. In some implementations, source information might include a visual representation of “office productivity documents,” such as a visual representation of a word processing document (perhaps using one or more “portable document formats”), presentation, spreadsheet, or the like. In each of these cases, the visual representation may be processed in the same or a similar fashion to generate image pyramid data, collection data, or other zoomable user interface information. In general, as used herein, the term “image” is not limited to referring only to, say, a digital photograph, but should be interpreted to refer to a visual representation of information.

As shown in the exemplary FIG. 1, image pyramid tiles may be generated from two exemplary pieces of source information: source information 117 and source information 127. (Of course, image pyramid tiles may in practice be generated from any number of pieces of source information.) In this example, suppose that the source information 117 is a photograph or image of size 512 by 512 pixels. In at least some implementations, then, the source information 117 may be split into four image pyramid tiles including the image pyramid tile 115. Each image pyramid tile created as a result of this splitting or dividing would in this example be an image with the approximate size of 256 by 256 pixels. The same might apply to the source information 127, which could be processed to generate four image pyramid tiles, including image pyramid tile 125. In the same or other implementations, the source information may be split into image pyramid tiles of a variety of other sizes or shapes. Once generated, each image pyramid tile might be stored in one or more of a variety of ways, including as separate files on disk, at particular locations in memory, and so on.

In addition to simply splitting or dividing the source information to generate image pyramid tiles, as explained previously, the process of generating zoomable user interface information may generate a variety of additional image pyramid tiles, including image pyramid tiles that provide a representation of the source information but at a lower resolution and through the use of smaller amounts of data. (Such lower resolution image pyramid tiles may then in some cases be used by a user interface client to show, for example, zoomed out views of a zoomable user interface.) For example, the source information 117 might in some implementations be down sampled from the native resolution image to one or more smaller resolution images, and then image pyramid tiles may be generated from the smaller versions of the same source information. In this context, down sampling refers generally to the act of producing a lower resolution or smaller set of data—perhaps representing an image—by discarding at least some of the information in the original source data. A variety of down sampling techniques exist in the art and may be used as part of down sampling an image or piece of source information when generating a zoomable user interface.

Continuing with the same example described previously with reference to FIG. 1, the source information 117—an image of size 512 by 512 pixels—might be down sampled to an image that is, say, approximately 341 by 341 pixels in size. The down sampled image might then be split into a set of image pyramid tiles again. In this case, for example, four image pyramid tiles, including the image pyramid tile 113 and the image pyramid tile 114, might be produced.

Continuing with the same process, even smaller resolution versions of the source information may be produced, including in this example, the image pyramid tile 112, the image pyramid tile 111, and the image pyramid tile 110. In some implementations, once the down sampled version of a piece of source information reaches a size that is equal to or smaller than the size of a common image pyramid tile—say, smaller than 256 by 256, in this example—then no further tiling or splitting may be performed. In this example, the image pyramid tiles 110, 111, and 112 may all be small enough to exist only as a single image pyramid tile.

In some implementations, the set of image pyramid tiles and any other information generated from a version of the source information at a particular resolution may be referred to as a “level.” So, for example, the image pyramid tile 115 (and the other three image pyramid tiles that are shown but not identified explicitly), would be associated with a particular level, the image pyramid tiles 113 and 114 (and the other two image pyramid tiles shown but not identified) would be associated with another level, and the single image pyramid tiles 110, 111, and 112, would each be associated with their own level. It should be noted that while only a particular number of levels are shown in FIG. 1, that in a variety of implementations any number of levels may be used.

In some implementations, a variety of additional data, or metadata, may be associated with image pyramids. For example, in some implementations there might be a single image pyramid per piece of source information, and image pyramid metadata might exist for each image pyramid. Image pyramid metadata might include information such as the size of the original source information, the maximum size of each tile, the format (JPEG, PNG, and so on) of each image pyramid tile, as well as a variety of other information. Image pyramid metadata might be stored in files, such as XML files conforming to an appropriate schema, might be stored in memory, might be generated dynamically, and so on.

As before, the same or a similar process may be used to generate a set of image pyramid tiles for the source information 127, including, in this example, the image pyramid tiles 120, 121, 122, 123, and 124.

In some implementations and for some user scenarios, a set of image pyramids, one for each image or piece of source information, may be sufficient to provide a zoomable user interface. For example, a user interface client might first request and display a single relatively small image pyramid tile from each image pyramid. For example, a client might request and display the image pyramid tile 110 and the image pyramid tile 120. If a user then zooms in to view a particular image or set of images more closely, the client might subsequently request the appropriate image pyramid tiles of larger sizes that are needed to display the particular portion of portions of particular images at a higher level of detail. For example, if a user zoomed in to the image that is associated with the image pyramid that includes image pyramid tile 110, and then zoomed in to the upper left hand corner of the image, the client might successively request the image pyramid tile 111, the image pyramid tile 112, the image pyramid tile 113 (not requesting the image pyramid tile 114 and other image pyramid tiles associated with the same level), and finally the image pyramid tile 115 (and not the other image pyramid tiles associated with the same level). In so doing, a user would be able to view the upper left hand corner of the source information 117 at a high resolution and in detail without being required to download the entire piece of source information.

While image pyramids alone may be sufficient in some cases to provide a zoomable user interface, including through the use of methods such as those described previously, a variety of issues may make additional techniques useful. For example, when using only image pyramids displaying a zoomable user interface may require sending a separate request for each image pyramid tile from different image pyramids, even when the image pyramid tiles are very small. So, for example, to display the initial zoomed out view of a set with, say, 200 pieces of source information, a user interface client may need to send 200 separate requests for very small image pyramid tiles. In practice, this might mean, for example, that a client must send 200 individual requests, each for a relatively small file with a file size of, say, less than a thousand bytes. In a situation like this, while the overall amount of data transferred may be small, the large number of requests can lead to poor performance, overloaded servers, and other problems.

To resolve at least some of these issues, some zoomable user interface implementations may provide for working with sets of information using “collections.” Generally, a collection should be understood to comprise a representation of one or more pieces of source information, suitably processed so as to more efficiently enable the display or providing of a zoomable user interface. In some implementations, a collection may use collection data, including collection tiles and possibly collection metadata.

For example, rather than require a user interface client to download or obtain small resolution versions of each image individually, a client may be able to download a single collection tile or a set of collection tiles that in turn include one or more small resolution versions of source information. In some implementations, the small resolution versions of the source information that are used to create a collection tile may be taken directly from or be derived from image pyramid information or, in some cases specifically, from image pyramid tiles. For example, as described with reference to FIG. 1, a user interface client might download a single collection tile 130, instead of individually downloading the image pyramid tile 110 and the image pyramid tile 120. The single image collection tile 130 in this example might include the images from both the image pyramid tile 110 and the image pyramid tile 120.

As with image pyramids, in some implementations a set of collection tiles (and possibly collection metadata, as discussed below) may have various levels, where successive levels include representations of the same source information or images, but at different resolutions. A user interface client might then retrieve the appropriate collection tile or collection tiles, depending on which images or source information is being viewed. As one example, with reference to FIG. 1, an additional collection tile 132 might include the image pyramid tile 111 and the image pyramid tile 121.

It should be noted that while FIG. 1 shows collection tiles at only two different sizes, collection tiles may in some implementations be generated at a large variety of different sizes and using a similarly large variety of different size or resolution source information or image pyramid tiles. Furthermore, in the same or other implementations, a collection tile may include a different and potentially larger number of images.

In at least some implementations, a collection might also have associated collection metadata, or information about the collection, about the collection tiles, and so on. Such metadata might include, for example, a list of the images or source information in the collection and information about the collection tiles available for the collection, which might in turn include, potentially for each level, information about the size of the image or information in each collection tile, an identification of where each image is located in a particular collection tile (for example, that one image is located at a pixel location of (0, 0) while another image is located offset at a pixel location of (0, 100), and so on), a suggested layout for the images in the collection, and the like. Collection metadata might be stored in files, such as XML files conforming to an appropriate schema, might be stored in memory, might be generated dynamically, and so on.

A user interface client that obtains one or more collection tiles and also possibly relevant or associated collection metadata may be able to retrieve the individual images from the collection tile(s) and manipulate or display them in a variety of ways. That is, images in a collection tile itself may be arranged in one way, but the manner in which images in a collection tile are organized does not limit how those images can be displayed by a client. In fact, in some implementations images may be arranged in collection tiles specifically in such a way that they are relatively easier for a client to retrieve. For example, images with different resolutions might be arranged in a grid, potentially with intervening “empty” space, so that executable code can more easily retrieve the image data at a particular location in the collection tile. In some implementations, collection metadata may include information to make such retrieval easier, including, as introduced previously, information about the size of each image in a collection tile and information about where in the collection tile each image is located.

Once a client has obtained one or more collection tiles, the client might retrieve individual images from the collection tiles and display them in alternative ways—for example, the client might display images in a row or as a timeline (perhaps organized by metadata such as creation time, or the like), in a “cloud” of images where images that are related in some fashion are shown in proximity to each other, and so on. Furthermore, in some implementations, a client may retrieve or obtain collection tiles from different layers and potentially display images (at different resolutions or sizes) together—as just one example, images in a cloud of images that are somehow determined to be more relevant or interesting might be displayed using larger resolutions.

A client might also provide for transitioning between information retrieved or obtained from collection tiles and the image pyramids themselves. For example, in at least some implementations, a client might use images from collection tiles until a user zooms in to some level of magnification, and then switch to using image pyramid tiles for a particular image or piece of source information (or multiple images or pieces of source information).

Finally, in some implementations, a variety of user interface techniques may be used to give the appearance to the user of a “continuous zoom.” That is, while images in collection tiles and image pyramid tiles may exist at various discrete resolutions, a client may use techniques such as client-only zooming, animation, and transitioning between different images to make it appear that an image or piece of source information can be viewed at any arbitrary resolution. For example, suppose that a single image is available at two resolutions—say, at 100 by 100 pixels and 200×200 pixels. The 200 by 200 pixel image in this case might generally contain four times as much image information as the 100 by 100 pixel image, and might in some implementations be represented as four image pyramid tiles each of the size 100 by 100 pixels. A user interface client might first download or obtain the 100 by 100 image pyramid tile that includes the entire image. Then, as a user zooms in to a particular part of the image—say, to the upper left hand corner of the image—the client might download one or more of the second set of image pyramid tiles. However, before any of the second set of tiles are used in the display—perhaps while one or more of the second set of tiles are being downloaded or obtained—the client might display the 100 by 100 pixel image at a larger resolution than 100 by 100 pixels, perhaps by making the pixels of the 50 by 50 pixel sub-square in the upper left hand corner of the image larger, so that they occupy the same space as 100 by 100 pixels in the original image. Then, when the upper left hand 100 by 100 pixel image pyramid tile has been downloaded or obtained, the client might transition, including through the use of animation, between the lower resolution image displayed at 100 by 100 pixels to the higher resolution image of the same size.

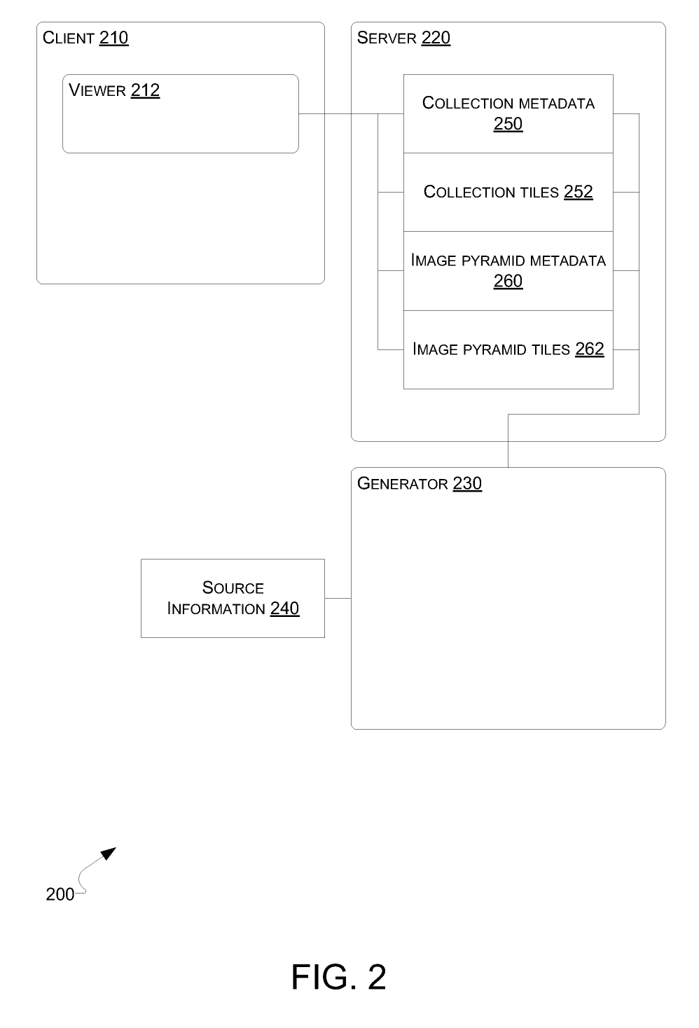

Turning now to FIG. 2, shown therein is an exemplary system 200 that demonstrates one manner in which zoomable user interface information may be generated and provided to a user interface client. The system includes a client 210 and a viewer 212, a server 220, a generator 230, and source information 240. The server in turn is shown as including collection metadata 250, collection tiles 252, image pyramid metadata 260, and image pyramid tiles 262. This description of FIG. 2 may be made with reference to other figures. However, it should be understood that the elements described with reference to FIG. 2 are not intended to be limited to being used with the elements described with reference to other figures. In addition, while the exemplary diagram in FIG. 2 indicates particular elements, in some implementations not all of these elements may exist, and in some implementations additional elements may exist. Furthermore, it should be understood that the exemplary graphical representations of the systems and user interfaces shown in FIG. 2, and in other figures included herein, are provided only for purposes of discussion, and in no way should be construed as limiting the scope of the techniques described herein to any particular graphical or other representation.

In some implementations, a set of one or more pieces of source information 240 may be provided to a generator 230. As introduced previously, the source information may be of a large variety of types, including, but not limited to, digital images. In at least some implementations, a generator may be an application or other executable code configured to accept or obtain source information and produce some or all of zoomable user interface information that may be used to provide a zoomable user interface. For example, a generator may be an application that a user runs on a local computing device, such as on a desktop or workstation computer. Using such a generator application, a user may, for example, specify one or more directories or folders that contain source information such as, say, digital images. The user might also provide additional information or configuration—for example, they might associate additional information, such as perhaps descriptive tags, with different pieces of source information. In the same or other implementations, they might provide or specify a default layout or organization for multiple pieces of source information—perhaps organizing source information in a grid, in a timeline, or in a variety of other fashions. The generator 230 might then generate or produce some or all of zoomable user interface information that may be used or useful to provide a zoomable user interface. For example, in some implementations, a generator might then produce some or all of image pyramid metadata 260, image pyramid tiles 262, collection metadata 250, and/or collection tiles 252. In at least some implementations, such zoomable user interface information may be the same as or similar to the zoomable user interface information of the same names as described previously with reference to FIG. 1.

In some implementations, some or all of the generated zoomable user interface information may be copied or moved from where it is generated to a server 220. In at least some of such implementations, or in other implementations, the zoomable user interface information—including some or all of image metadata 260, image pyramid tiles 262, collection metadata 250, and collection tiles 252, and possibly also other information—may then provided or served from the server, as shown in FIG. 2. For example, in a case where the zoomable user interface information is generated on a local or desktop computer, a user might copy the resulting information to a file or web server. Such a server may in some implementations be accessible from a wide number of locations—including perhaps being accessible from the public Internet, may be faster or otherwise better suited for supplying zoomable user interface information, and so on. In at least some implementations, including those where the zoomable user interface information (including possibly image pyramid tiles, image pyramid metadata, collection tiles, and collection metadata) is represented as files, the server may not have any specific or particular knowledge about zoomable user interfaces. That is, for example, the server may simply serve files (that happen to contain zoomable user interface information)—it may not have any knowledge that the information it is serving or providing is relevant for displaying zoomable user interfaces.

Finally, a client 210 with a viewer 212 may request and obtain some or all of the zoomable user interface information from the server 220. For example, in some implementations, the client might include a user's computer on which is installed or available a viewer application or executable code that can retrieve and/or interpret zoomable user interface information. In just some examples, and without limitation, a viewer might include a web browser application in which a plug-in or other executable code is installed or available, and that can submit requests and/or retrieve some or all of the zoomable user interface information discussed herein, including image metadata 260, image pyramid tiles 262, collection metadata 250, and collection tiles 252. In at least some implementations, a developer or creator of a user interface—say, a person designing an HTML or web page—may be able to “embed” or include, for example, markup or other user interface instructions that load a viewer from a network location. In some implementations, such markup, or other markup, may also indicate or specify the zoomable user interface information to be displayed by the viewer.

For example, a user might browse to a page in which a viewer applet or other executable code is referenced. Upon the loading of such a page, the viewer may retrieve, for example, collection metadata and/or collection tiles appropriate for displaying a zoomed out view of a set of source information. For example, the viewer may retrieve one or more collection tiles that include relatively small or low resolution versions of at least some of the source information, along with possibly associated collection metadata. From these collection tiles and possibly using the collection metadata, the viewer may extract or retrieve some or all of the small versions of the source information, and may then display the small versions of the source information using, possibly in part and for example, layout information included in or referenced by the collection metadata. When a user viewing the information displayed by the viewer pans or zooms, the viewer may then retrieve additional zoomable user interface information, including possibly additional collection tiles (or collection metadata), as well as image pyramid tiles and image pyramid metadata.

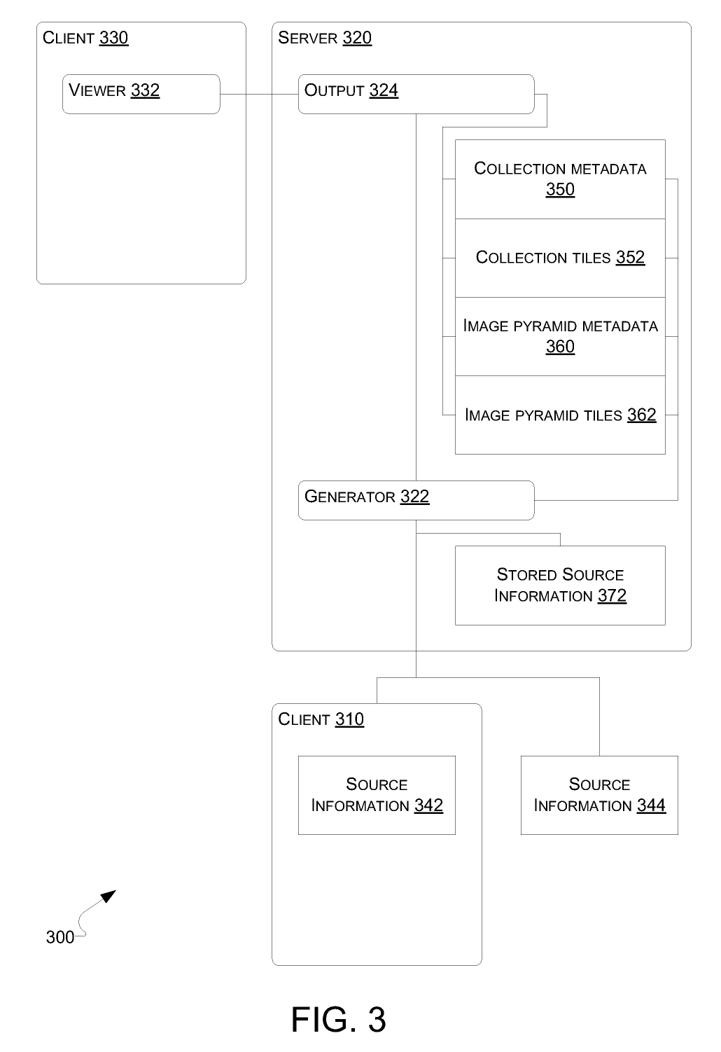

Turning now to FIG. 3, shown therein is an exemplary system 300 that demonstrates one manner in which zoomable user interface information may be generated on a server and provided to a user interface client. The system includes a client 330 and a viewer 332, a server 320, a client 310 and source information 342, and source information 344. The server in turn is shown as including an output module 324, collection metadata 350, collection tiles 352, image pyramid metadata 360, image pyramid tiles 362, a generator module 322, and stored source information 372. This description of FIG. 3 may be made with reference to other figures. However, it should be understood that the elements described with reference to FIG. 3 are not intended to be limited to being used with the elements described with reference to other figures. In addition, while the exemplary diagram in FIG. 3 indicates particular elements, in some implementations not all of these elements may exist, and in some implementations additional elements may exist. Furthermore, it should be understood that the exemplary graphical representations of the systems and user interfaces shown in FIG. 3, and in other figures included herein, are provided only for purposes of discussion, and in no way should be construed as limiting the scope of the techniques described herein to any particular graphical or other representation.

As the description provided previously with reference to FIG. 2 has explained, typically zoomable user interface information has been generated on one particular computing device and then moved to or provided from some other computing device. Zoomable user interface information has also typically been generated statically—that is, for already defined or pre-defined sets of source information. Among many reasons, this may have been the case because of the relatively large amount of computational resources often required to generate such zoomable user interface information. As one example, the act of down sampling each piece of source information multiple times, to create potentially many different versions of the source information with different resolutions, may be relatively computationally intensive. As another example, the potentially large number of different pieces of source information that might exist in a particular set or collection can make the creation of collection-specific zoomable user interface information—collection metadata and collection tiles—relatively resource-intensive in possibly multiple different ways, including by requiring retrieval of information from a large number of different files and possibly different locations on one or more storage devices. These technical challenges, and a lack of readily apparent solutions, may have previously limited the generation of zoomable user interface information to the “off-line” or static generation processes previously described.

As shown in FIG. 3, a generator module 322 may exist on a server 320 or on some other computing device. Such a generator module may generally produce some or all of the zoomable user interface information useful for providing or enabling a zoomable user interface, including, for example, image pyramid metadata 360, image pyramid tiles 362, collection metadata 350, and collection tiles 352. In some implementations, a generator module might be provided with source information 342 from a client 310. For example, as one of many possible implementations, a user that wants to create one or more zoomable user interfaces might browse to a web site associated with the server, specify some set of source information that exists on the client—such as a set of digital images, and then upload the source information to the server.

Upon receipt of the provided source information, the information might be stored, for example, in some storage medium, such as one or more disk drives or memory devices, associated with the server, as represented by the stored source information 372. In the same or other implementations, at least some source information may be only present on the server for some transient period of time, such as perhaps the time necessary to generate some amount of zoomable user interface information, after which time the original source information may not be further stored. In the same or other implementations, the source information might be stored on one or more other computing or storage devices.

In the same or other implementations, a generator module or other executable code associated with the server might retrieve one or more pieces of source information 344 from one or more locations or other computing devices. As just one example, such source information might be retrieved by monitoring or retrieving an RSS or Atom feed, or some other data source, that identifies a set of digital images, and retrieving newly added images. Such retrieved source information may, in some implementations, be stored as stored source information 372, as described previously, or may only exist on the server for a temporary period of time, also as described previously. Through the retrieval of such information, it may be possible for a set of source information and one or more zoomable user interfaces to be kept “in sync” with information maintained by some other entity, on some other site, and so on. That is, for example, when a user, say, adds a new photo using a separate photo-sharing site, that photo may be automatically incorporated into one or more zoomable user interfaces.

In some implementations, a generator module 322 might produce some or all of image pyramid metadata 260, image pyramid tiles 262, collection metadata 250, and/or collection tiles 252, and may do so using some combination of the source information 342, source information 344, and stored source information 372, as well as possibly other source information. In at least some implementations, such generated zoomable user interface information may be the same as or similar to the zoomable user interface information of the same names as described previously with reference to FIG. 1. Furthermore, in at least some implementations one or more of a variety of optimizations in the way that zoomable user interface information may be generated by a generator module may be used so that the generation of zoomable user interface can be practically or more efficiently implemented on a server or at scale. Some of such optimizations are explained below.

Finally, in some implementations an output module 324 may provide zoomable user interface information to a viewer 332 that might exist on some client 330. The zoomable user interface information provided by the output module and consumed and used by the viewer may in some implementations be the same as or similar to the zoomable user interface information generated by a generator process or executable code that does not operate on a server, including, for example, the separate generator described previously with reference to FIG. 2.

It should be noted that although the generator module 332, output module 324, and collection, image pyramid, and source information are illustrated as being associated with a single server 320, that this is not required. In fact, each of these pieces may, in at least some implementations, be located on different computing devices. Furthermore, in some implementations, particular elements may even be operated by separate companies or organizational entities. For example, a company might manage the storage of particular information themselves, but use a generator module provided or operated entirely by another company, perhaps as a “service.” In the same or other implementations, a company or entity might provide “components,” installable software, or the like, that another company or entity could install or execute on their own servers to provide some or all of the functionality described herein.

To the extent that there is a similarity between statically generated zoomable user interface and dynamically generated information, the viewer 332 that interprets and uses such information may not need to change when using dynamically generated information. In fact, in at least some implementations, the viewer and client may not even know that the zoomable user interface information may have been generated differently or might not even have existed at the time a request was made. Regardless of how the zoomable user interface information is generated, a viewer may operate to retrieve relevant parts of the zoomable user interface information associated with a set of source information, including by retrieving lower resolution versions of at least some source information and then retrieving higher resolution versions of the same or other source information as a user interacts with the viewer, as described elsewhere herein.

Stated in another way, at least in some implementations, one or more optimizations may be made by “breaking the link” between what the client receives and what exists on the server that provides the zoomable user interface information. That is, in at least some previous implementations the viewer requests and receives information as it exists on the server. For example, a viewer might request a particular part of an image, and the server might respond by retrieving and returning an already generated image file. A variety of improvements can be made when the server has the capability of dynamically generating or modifying what is provided to the client viewer, even to the point where—in some examples—the information provided to the client does not even exist until after the request for that information is made.

In at least some implementations, one or more optimizations may improve the process of generating image pyramid information, including especially image pyramid tiles. As has been previously explained, the process of generating image pyramid tiles may in many implementations be relatively time consuming due to, for example, the amount of computation required to generate multiple alternative resolution versions of a particular piece of source information. One optimization that can be made may relate to when the image pyramid information is generated. For example, in some implementations, rather than waiting until all of the source information has been provided or retrieved—as might be done with a stand-alone generator, including those described previously with reference to FIG. 2—image pyramid tiles may instead be generated during the process of providing or retrieving the source information. That is, for example, as soon as the first piece of source information is provided, retrieved, or available to the generator module, the generator module may start the generation of image pyramid tile information. At the same time as this image pyramid tile generation occurs, further pieces of source information may be obtained. In effect, this technique may take advantage of typical latency in transferring relatively large amounts of information—such as large digital photos—across networks. That is, while generating image pyramid tile information may take a long time compared to, say, storing such information on a disk, in most implementations generating image pyramid tile information will still generally take less time than, say, retrieving subsequent pieces of source information from some network location. As a result, the majority of image pyramid tile information may be already generated when the process of obtaining or being provided the source information has completed.

In the same or other implementations, image pyramid information may be generated at other alternative times. For example, depending on the nature of the source information, in some implementations the generation of image pyramid information may be started even before the entire piece of source information has been obtained. In the same or other implementations, a particular amount of source information may be obtained before the generation of image pyramid information begins. In yet other, or the same implementations, image pyramid information may in some cases only be generated when such image pyramid information is actually requested by a viewer or other client. In some implementations, such on-demand generation of image pyramid information may increase the amount of time a client must wait for desired information, but such a delay may be satisfactory depending on other characteristics of the request. For example, as will be discussed briefly in more detail below, a provider might charge less for on-demand generation than pre-generation of image pyramid or other information.

Another method of optimization as well as a way to provide functionality that might not be possible with previous techniques for generating zoomable user interface information is the dynamic generation of collection information, including the collection metadata and collection tile information that provide the ability to more quickly or efficiently obtain and display sets of source information. In previous techniques, including those explained with reference to FIG. 2, collection metadata and collection tiles were generated once, before they were made available to clients, and were also typically generated at approximately the same time as the associated image pyramid information. In some alternative implementations, collection information may be generated at different times, and therefore—perhaps more importantly—collection information that would not have been generated may, as a result, be practical to generate and provide.

In one example, at least some collection information may not be generated until a request is made for a collection or for particular collection information. In contrast to the generation of image pyramid information, which can be time consuming, as previously explained, generating collection metadata and collection tiles may sometimes be performed relatively quickly and as a result it may be practical to only produce at least some collection metadata and collection tiles when they are requested. (This may be especially the case when other optimizations are made, including perhaps one or more of the optimizations described below.) So, for example, in some implementations, upon receiving a request for a particular collection, a generator module may generate the requested collection information. Such generation may be accomplished using a variety of techniques, including by retrieving or obtaining appropriately-sized (possibly relatively small) image pyramid information for the source information in the collection, and by building the appropriate collection metadata and collection tiles. In some implementations, such generated collection information may then be stored and possibly used to service further requests for the same or related collections, while in other implementations the generated collection information may be discarded immediately or at some point after it is used.

An ability to dynamically generate collection information can enable the providing of a wide range of functionality that would be difficult or impossible to provide with static generation of collection information, including enabling many scenarios where the collection is not generally known beforehand or may be retrieved so infrequently that it is not economical to generate it before it is requested. As one example, enabling the ability to view the results of an image search may require the ability to efficiently generate collection information. As another example, the ability to dynamically generate collection information may enable the generation of a wide range of “personalized” zoomable user interface information that is customized for a particular user or set of users, such as zoomable user interfaces that only include digital photos that are somehow relevant to a particular user, and the like.

While generating collection information may often be less time-consuming than generating, for example, image pyramid information, generating collection information, especially at large scales, can still require significant amounts of time and can still benefit from optimization. For example, often a single collection tile will incorporate a large number of relatively small images—as just one example, just a single collection tile of size 256 by 256 pixels that includes images of size 4 by 4 pixels might require as many as 4096 images (64 images in each row horizontally, and 64 rows). Even if each of the 4096 images already exist as, say, a file stored in a file system implemented using disk storage, it may take a significant time to retrieve each image, due to the overhead associated with requesting 4096 separate files. This problem only becomes worse when one considers that many collection tiles may be generated for a single collection.

To at least partially address this problem, at least some image pyramid information, including image pyramid information that may be used as part of generating collection tiles, might in some implementations be stored in alternative ways. For example, image pyramid information, especially perhaps that information associated with lower resolution versions of source information (because of its relevance for collection tile generation) may not be stored (or may not only be stored) as separate or discrete files. Instead, such information might be stored, for example, in one or more “packed” organizations. As just one specific example, a set of images—perhaps all of the same size or associated with the same image pyramid or collection level—might be stored together in a single file—for example, as an archive or ZIP file. Using this packed organization, a generator module may only need to request a single file, or at least a much smaller number of files, to generate a particular collection tile or set of collection tiles. In the same or other implementations, images may be stored in random access memory, or other storage without the latencies or overhead associated with disk-based or other similar storage. In the same or other implementations, such information may be stored in multiple ways—for example, as both packed files and as single files, in memory and in single files on disk, and so on.

Some or all of the optimizations and techniques described herein may be used, perhaps selectively, depending on additional factors, including, for example, the amount of money or compensation associated with a particular customer or set of data, the nature of the business or other relationship with a particular user or customer, and so on. In some implementations, a “higher cost service option,” such as a higher monetary or other cost (in preferential access, or some other benefit) may be associated with one or more types of preferential service. For example, a particular customer might pay more to ensure faster access to particular zoomable user interfaces. Such faster access might be provided, at least in part and for example and without limitation, by pre-generating more zoomable user interface information. Other customers, perhaps those that pay less, might only receive, for example and again without limitation, on-demand and so possibly slower access to particular zoomable user interfaces. In the same or yet other implementations, one or more generator modules may constantly generate zoomable user interface information—to, say, not waste any available processor time—but the zoomable user interface information associated with preferred customers, including those that use a higher cost service option, may be prioritized above other customers.

It should be noted that in general the results provided by a server, such as the server 320, to a viewer 332 may be used by the viewer and the client 330 in a wide variety of ways, as has been previously introduced and discussed elsewhere herein. One particular use of note, and without limitation, especially when dynamic generation of zoomable user interface information is discussed, is in displaying the results of a search for visual information. For example, an “image search” might (dynamically in many cases) identify a set of images that are associated somehow with a particular search query. Rather than simply generate, say, a thumbnail or low resolution version of each identified image and then display the thumbnails in a grid, a zoomable user interface could be used to display the search results in a different and in many cases more usable or attractive representation. For example, images that are determined to be more relevant might be distinguished in one or more fashions, such as, for example, by being displayed using higher resolution versions of the images when compared with images with lower relevance.

As another example, if particular elements in the search results can be determined to be related, the images associated with such related results may be shown located together, or may be shown as associated or related in one or more other fashions. So, for example, a search for “tower” might show a cluster of images with, say, the Eiffel Tower, in one part of the user interface, another cluster of images with the Space Needle in another part of the user interface, and so on.

Furthermore, common zoomable user interface interactions, such as zooming, may in some cases be used to, for example, refine a search query and/or to execute additional queries. For example, using the previous “tower” search example, if a user zooms into an area of the user interface that includes one or more images of the Eiffel Tower, an additional query might be executed using terms such as “Eiffel Tower,” and additional or new zoomable user interface information might be generated with further or more detailed information associated with the Eiffel Tower.

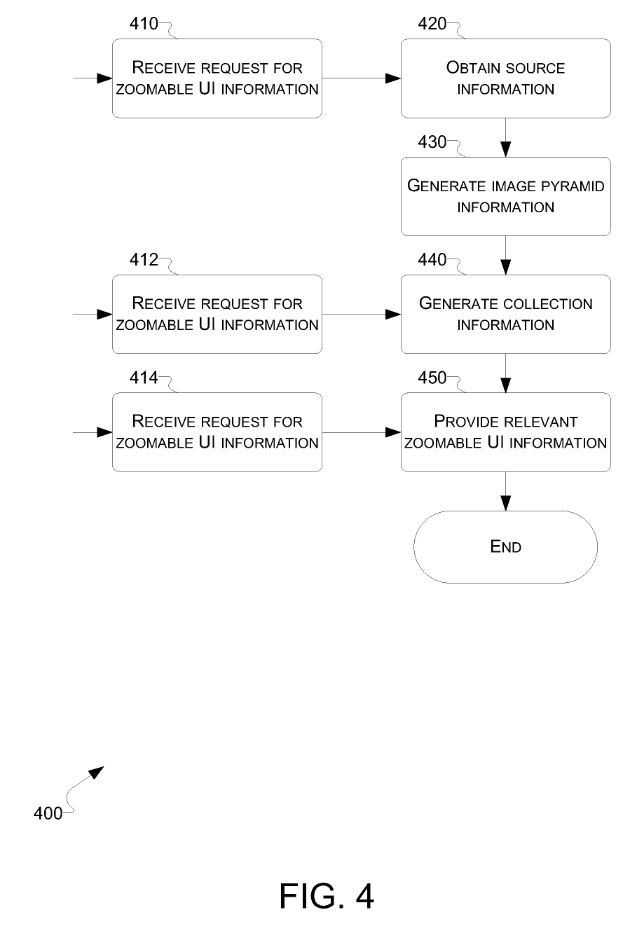

Turning now to FIG. 4, shown therein is an exemplary generalized operational flow 400 including various operations that may be performed when servicing requests for zoomable user interface information. The following description of FIG. 4 may be made with reference to other figures. However, it should be understood that the operational flow described with reference to FIG. 4 is not intended to be limited to being used with the elements described with reference to these other figures. In addition, while the exemplary operational flow of FIG. 4 may indicate a particular order of execution, in one or more alternative embodiments the operations may be ordered differently. Furthermore, while the exemplary operational flow is shown as including multiple discrete steps, it should be recognized that in some implementations at least some of these operations may be combined or executed contemporaneously.

As described elsewhere herein, a request for zoomable user interface information may be received from a client or viewer that may then subsequently display the zoomable user interface. Such a request may be serviced by a server in a variety of ways. Generally, in at least some implementations, such a request may include some information that defines or identifies particular zoomable user interface information, some subset of zoomable user interface information, a particular set or subset of source information, and so on, as is described elsewhere herein. As just one example, an initial request may specify that lower resolution images are desired, while a later request might specify particular higher resolution sections of a particular piece of source information. In addition, it should be noted that a request from a client or viewer that will display the zoomable user interface need not come directly from the client or viewer—that is, such a request may be relayed through, for example, other computer devices or networks, before being received by a server.

As shown in FIG. 4, one way to differentiate between requests for zoomable user interface information is by when the request is received. While not all times at which a request may be received are illustrated in FIG. 4, in some implementations or scenarios, a request may be received, as in operation 410, when no source information has been obtained or zoomable user interface information generated; a request may be received, as in operation 412, when source information has already been obtained and image pyramid information has been generated, but the relevant collection information has not been generated or does not exist—such may be the case when dynamic collections are used, for example; and a request may be received, as in operation 414, when source information and zoomable user interface information (both image pyramid and collection information) has been generated.

Regardless of when a request for zoomable user interface information is received, generally to service such a request source information must be obtained at some point in time, as in, for example, operation 420. As described elsewhere herein, such source information may comprise a wide variety of types, retrieved from a wide variety of locations, and so on. In some implementations, a server or generator may retrieve source information, while in other implementations a user or some other client or entity may provide source information.

Given some source information, in operation 430 image pyramid information, including in some implementations image pyramid metadata and image pyramid tiles, are generated. Such generation of image pyramid information may proceed as has previously been described, for example, with reference to FIG. 1, FIG. 2, and FIG. 3.

In addition to the generation of image pyramid information, in at least some implementations, collection information, including possibly collection metadata and collection tiles, may be generated in operation 440. As with image pyramid information, the generation of collection information may proceed as is described elsewhere herein, including with reference to FIG. 1, FIG. 2, and FIG. 3.

Finally, and in some implementations in ways described elsewhere herein, zoomable user interface information relevant or appropriate to the request may be provided or returned to the requesting client in operation 450.

### Example Computing Environment

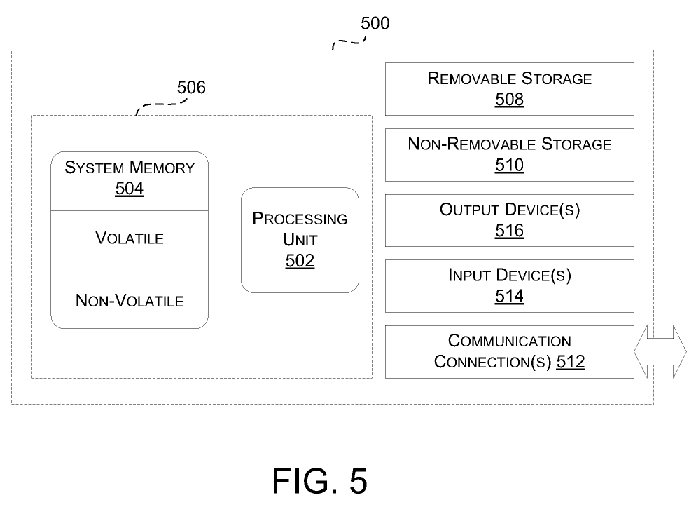

Turning now to FIG. 5, this figure and the related description are intended to provide a brief and general description of an exemplary computing environment in which the various technologies described herein may be implemented. Although not required, the technologies are described herein, at least in part, in the general context of computer-executable instructions, such as program modules that are executed by a controller, processor, personal computer, or other computing device, such as the computing device 500 illustrated in FIG. 5.

Generally, program modules include routines, programs, objects, components, user interfaces, data structures, and so on, that perform particular tasks, display particular information, or implement particular abstract data types. Operations performed by the program modules have been described previously with the aid of one or more block diagrams and operational flows.

Those skilled in the art can implement the description, block diagrams, and operational flows in the form of computer-executable instructions, which may be embodied in one or more forms of computer-readable media. As used herein, computer-readable media may be any media that can store or embody information that is encoded in a form that can be accessed and understood by a computer. Typical forms of computer-readable media include, without limitation, both volatile and nonvolatile memory, data storage devices, including removable and/or non-removable media, and communications media.

Communication media embodies computer-readable information in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communications media includes wired media such as a wired network or direct-wired connection, and wireless media such as acoustic, RF, infrared, and other wireless media.

The computing device 500 illustrated in FIG. 5, in its most basic configuration, includes at least one processing unit 502 and memory 504. In some implementations, the computing device 500 may be implement, at least in part, and for example, a client 210, a server 220, a generator 230, a client 310, a server 320, or a client 330, as described with reference to FIG. 2 and FIG. 3. In some implementations, the processing unit 502 may be a general purpose central processing unit (CPU), as exists, for example, on a variety of computers, including desktop and laptop computers. Depending on the exact configuration and type of computing device, the memory 504 may be volatile (such as RAM), non-volatile (such as ROM, flash memory, etc.), or some combination of the two. This most basic configuration is illustrated in FIG. 5 by dashed line 506. Additionally, the computing device 500 may also have additional features and functionality. For example, the computing device 500 may also include additional storage (removable and/or non-removable) including, but not limited to, magnetic or optical disks or tape. Such additional storage is illustrated in FIG. 5 by the removable storage 508 and the non-removable storage 510.

The computing device 500 may also contain one or more communications connection(s) 512 that allow the computing device 500 to communicate with other devices and services. For example, the computing device might have one or more connections to a variety of communication means or computing devices, including for example, connections between the client 210, the server 220, and/or the generator 230, of FIG. 2, or connections between the client 310, the server 320, and the client 330, of FIG. 3. The computing device 500 may also have one or more input device(s) 514, including, for example, image input devices like cameras or scanners, keyboards, mice, pens, voice input devices including microphone arrays, touch input devices, and so on. One or more output device(s) 516 such as a display, speakers, printer, and so on, may also be included in the computing device 500.

Those skilled in the art will appreciate that the technologies described herein may be practiced with computing devices that may be the same as or different from the computing device 500 illustrated in FIG. 5. For example, and without limitation, the technologies described herein may likewise be practiced in hand-held devices including mobile telephones and PDAs, multiprocessor systems, microprocessor-based or programmable consumer electronics, network PCs, minicomputers, mainframe computers, and so on. Each of these computing devices may be described, at some level of detail, by the system of FIG. 5, or may be described differently.

The technologies described herein may also be implemented in distributed computing environments where operations are performed by remote processing devices that are linked through a communications network. In a distributed computing environment, program modules may be located in both local and remote devices.

While described herein as being implemented in software, it will further be appreciated that the technologies described herein may alternatively be implemented all or in part as hardware, firmware, or various combinations of software, hardware, and/or firmware.

Although some particular implementations of methods and systems have been illustrated in the accompanying drawings and described in the foregoing text, it will be understood that the methods and systems shown and described are not limited to the particular implementations described, but are capable of numerous rearrangements, modifications, and substitutions without departing from the spirit set forth and defined by the following claims.

What is claimed is:

1. One or more computer-readable storage media comprising computer-executable instructions stored thereon, the computer-executable instructions, when executed, configuring a system to perform actions comprising:
receiving a request from a user interface client for zoomable user interface information;
generating, in response to the request, a generated portion of the zoomable user interface information, the generated portion associated with a collection and the collection being derived from one or more pieces of source information;
providing a request portion of the zoomable user interface information in response to the request, the request portion of the zoomable user interface information including at least some of the generated portion of the zoomable user interface information.

2. The one or more computer-readable storage media as recited in claim 1, wherein the zoomable user interface information further comprises at least versions of the same source information having different resolutions, and wherein the user interface client selectively obtains a subset of the zoomable user interface information so as to enable display of particular areas of interest associated with the source information.

3. The one or more computer-readable storage media as recited in claim 1, wherein the generated portion of the zoomable user interface information further comprises collection data and the collection data includes collection metadata and collection tiles, the collection tiles being formed from one or more images associated with the one or more pieces of source information.

4. The one or more computer-readable storage media as recited in claim 3, wherein the collection metadata further comprises information that specifies one or more of the following:
an identification of at least some of the one or more images;
a size of at least one of the one or more images;
a position of at least one of the one or more images in one or more collection tiles;
a number of levels present in the collection data; and
an identification of where image pyramid information can be found for at least one of the one or more images.

5. The one or more computer-readable storage media as recited in claim 1, wherein the zoomable user interface information further comprises an image pyramid including image pyramid tiles, and the image pyramid is associated with one or more images retrieved or derived from the one or more pieces of source information.

6. The one or more computer-readable storage media as recited in claim 5, wherein the computer-executable instructions further configure the system to perform an action comprising:
creating at least some of the image pyramid tiles.

7. The one or more computer-readable storage media as recited in claim 6, wherein the creating at least some of the image pyramid tiles is performed at least in part by splitting one or more of the images on defined boundaries.

8. The one or more computer-readable storage media as recited in claim 6, wherein the creating at least some of the image pyramid tiles is performed at least in part by down sampling one of the images to create at least two down sampled images and splitting the down sampled images and the image on defined boundaries.

9. The one or more computer-readable storage media as recited in claim 5, wherein the generated portion of the zoomable user interface information further comprises collection data including collection tiles, and at least one of the collection tiles is formed using two or more of the image pyramid tiles.

10. The one or more computer-readable storage media as recited in claim 5, wherein the generated portion of the zoomable user interface information further comprises collection data including collection tiles, and two or more of the collection tiles are formed by combining at least some part of two or more of the image pyramid tiles into a single collection image and then splitting the single collection image on defined boundaries.

11. The one or more computer-readable storage media as recited in claim 6, wherein the creating image pyramid tiles is performed at a time substantially separate from and before a time in which the generating of the generated portion of the zoomable user interface information is performed.

12. The one or more computer-readable storage media as recited in claim 11, wherein the creating the image pyramid tiles is performed before at least in part because the request is associated with a higher cost service option.

13. The one or more computer-readable storage media as recited in claim 6, wherein the creating image pyramid tiles begins when a sufficient amount of source information is available, even if not all of the source information is available when the creating begins.

14. The one or more computer-readable storage media as recited in claim 1 wherein a second generated portion of the zoomable user interface information comprising a more commonly requested part of the zoomable user interface information is generated in advance of the request.

15. The one or more computer-readable storage media as recited in claim 5, wherein the two or more image pyramid tiles are stored in one or more single files.

16. The one or more computer-readable storage media as recited in claim 1, wherein the one or more pieces of source information include at least one visual representation of graphical data and at least one of the one or more pieces of source information is not a digital photograph.

17. The one or more computer-readable storage media as recited in claim 1 wherein the request is generated as part of implementing a search and the collection is associated with a set of search results that are relevant to the search.

18. The one or more computer-readable storage media as recited in claim 17, wherein a second request is associated with refining the search by zooming in to a particular part of the zoomable user interface.

19. A system for servicing a request for zoomable user interface information on a server computing device configured to provide zoomable user interface information to multiple clients, comprising:
a generator module configured to generate zoomable user interface information using source information and using one or more optimizations to enable efficient generation of zoomable user interface information for the multiple clients, the optimizations relating to generating different portions of the zoomable user interface information at different times; and
an output module configured to provide some or all of the zoomable user interface information in response to a request for the zoomable user interface information.

20. One or more computer-readable storage media comprising computer-executable instructions stored thereon, the computer-executable instructions, when executed, configuring a system to perform actions comprising:
creating at least one image pyramid including image pyramid tiles, the at least one image pyramid being associated with one or more images retrieved or derived from one or more pieces of source information;
receiving a request from a user interface client for zoomable user interface information at a time substantially separate from and after the at least one image pyramid has been created, the user interface client being configured to selectively obtain portions of the zoomable user interface information so as to enable display of particular areas of interest associated with the source information, and the zoomable user interface information including at least versions of the same pieces of source information having different resolutions;
generating, in response to the request, a generated portion of the zoomable user interface information, the generated portion associated with a collection and further including collection metadata and collection tiles, the collection tiles being formed using two or more of the image pyramid tiles; and
providing a request portion of the zoomable user interface information in response to the request, the request portion of the zoomable user interface information including at least some of the generated portion of the zoomable user interface information.
